(19) United States
(12) Patent Application Publication
(10) Pub. No.: US 2026/0179266 A1
(43) Pub. Date: Jun. 25, 2026

(54) IMAGE GENERATING SYSTEM, IMAGE GENERATING METHOD, AND STORAGE MEDIUM

(71) Applicant: KONICA MINOLTA, INC., Tokyo (JP)

(72) Inventors: Kouichi TOMITA, Kawanishi-shi (JP); Kazuma SAWA, Osaka (JP)

(73) Assignee: KONICA MINOLTA, INC., Tokyo (JP)

(21) Appl. No.: 19/422,920

(22) Filed: Dec. 17, 2025

(30) Foreign Application Priority Data
Dec. 25, 2024 (JP) 2024-228131
Dec. 25, 2024 (JP) 2024-228132

(51) Int. Cl. G06T 11/00; G06V 10/776

(52) U.S. Cl. CPC G06T 11/00; G06V 10/776

(57) ABSTRACT

An image generating system includes: a hardware processor that is configured to acquire concept information including a concept of an image desired by a user and a target value in an evaluation value of image data, cause a generative AI model to generate a plurality of image data based on a prompt corresponding to the acquired concept information, evaluate each of the generated image data, and select at least one image data in which the evaluated evaluation value is closer to the target value.

### CROSS-REFERENCE TO RELATED APPLICATION

The entire disclosure of Japanese Patent Application No. 2024-228131 and No. 2024-228132, filed on Dec. 25, 2024, including description, claims, drawings and abstract is incorporated herein by reference.

### BACKGROUND OF THE INVENTION

### Technical Field

The present disclosure relates to an image generating system, an image generating method, and a storage medium.

### Description of Related Art

Conventionally, it is difficult for a non-designer to prepare an effective advertisement or a leaflet and the non-designer has no choice but to place an order to an outside designer at a high cost. Therefore, a support service is known which provides various templates and creates image data such as an advertisement based on the templates. However, this is a method of providing the template, and is not a method of finally finishing an effective design.

Therefore, a technique for presenting a design is known. For example, there is known a design modification apparatus that performs an attention evaluation and an impression evaluation on an input image and presents a modification plan for a color and brightness of a design based on an evaluation result (see Japanese Unexamined Patent Publication No. 2024-75015).

In addition, a design generating apparatus is known which displays a region changed with a color correlated with an input keyword by using correlated information of words and colors mapped in advance (see Japanese Unexamined Patent Publication No. 2012-221400).

In the above-described conventional design modification apparatus and design generating apparatus, a plan to modify or change is not always what a user (in particular, a non-designer) desires. Furthermore, the proposal for modification or change is only to change the color or the like of an existing image, and no new image data can be proposed.

Conventionally, a technology for generating image data of a concept desired by a user has been known. For example, an image selection device is known that provides a photograph that meets the desires of a photographer (see Japanese Unexamined Patent Publication No. 2004-361989). The image selection device takes in a moving image of a subject from a camera for a predetermined amount of photographing time, and subdivides the moving image for each predetermined amount of time to extract a plurality of candidate images. The image selection device determines the orientation of the face in a person image of each candidate image, and calculates the evaluation value of each candidate image based on the determination result. The image selection device selects the image with a desired face orientation from among the plurality of candidate images on the basis of the calculated evaluation value.

Furthermore, a face image processing apparatus is known which automatically determines a facial expression and acquires a desired image (see Japanese Unexamined Patent Publication No. 2012-186821). The face image processing apparatus detects a face image, inputs images of a plurality of persons including the face image and determines whether the face of each of the plurality of persons is directed to the front or not or the opening/closing state of the eyes. The face image processing apparatus selects and outputs the image having the highest evaluation value of the facial expression for each person.

The above-described conventional image selection device selects the image with a desired face orientation. The above-described conventional face image processing apparatus also selects a state in which the face faces the front and the eyes are open. Therefore, although it is possible to obtain an image that meets the desire for the orientation of the face, it is not possible to obtain an image that meets any desire. In addition, each of the above-described conventional apparatuses selects a desired image from actually captured images, and cannot newly generate a desired image.

In recent years, image generating artificial intelligence (AI) has been rapidly developing. The image generating AI is a service or software that automatically generates image data in a completed form only by mainly giving an idea or atmosphere of a completed form as text or image data. In the image generating AI, it is currently quite difficult to generate the image with a concept intended by the user. A certain level of image generating control can be performed with prompts as input text, but its accuracy is limited. In addition, as a feature of the image generating AI, even when the same prompt is used, image data to be output is different every time. Therefore, it is necessary to repeatedly generate the image data until image data intended by the user is generated.

### SUMMARY OF THE INVENTION

A first object of the present disclosure is to easily generate image data desired by a user from a concept of an image.

A second object of the present disclosure is to appropriately and efficiently obtain desired image data.

To achieve at least one of the abovementioned objects, according to an aspect of the present disclosure, an image generating system reflecting one aspect of the present disclosure includes a hardware processor that is configured to acquire concept information including a concept of an image desired by a user and a target value in an evaluation value of image data, cause a generative AI model to generate a plurality of image data based on a prompt corresponding to the acquired concept information, evaluate each of the generated image data, and select at least one image data in which the evaluated evaluation value is closer to the target value.

According to another aspect of the present disclosure, an image generating method reflecting one aspect of the present disclosure includes,
acquiring concept information including a concept of an image desired by a user and a target value in an evaluation value of image data;
causing a generative AI model to generate a plurality of image data based on a prompt corresponding to the acquired concept information;
evaluating each of the generated image data; and
selecting at least one image data in which the evaluated evaluation value is closer to the target value.

According to another aspect of the present disclosure, a computer-readable storage medium storing a program reflecting one aspect of the present disclosure includes a program that causes a hardware processor in a computer to:
acquire concept information including a concept of an image desired by a user and a target value in an evaluation value of image data, cause a generative AI model to generate a plurality of image data based on a prompt corresponding to the acquired concept information, evaluate each of the generated image data, and select at least one image data in which the evaluated evaluation value is closer to the target value.

According to another aspect of the present disclosure, an image generating system reflecting one aspect of the present disclosure includes, a hardware processor that is configured to, acquire first concept information including a concept of an image desired by a user, generate a predetermined number of sheets of image data by inputting the acquired first concept information to a first generative AI model that generates the image data based on the concept information, generate second concept information by inputting the generated image data in a second generative AI model that generates the concept based on the image data, and evaluate, for each image data, a degree of similarity between the first concept information and the second concept information.

According to another aspect of the present disclosure, an image generating method reflecting one aspect of the present disclosure includes,
acquiring first concept information including a concept of an image desired by a user,
generating a predetermined number of sheets of image data by inputting the acquired first concept information to a first generative AI model that generates the image data based on the concept information,
generating second concept information by inputting the generated image data in a second generative AI model that generates the concept based on the image data, and
evaluating for each image data, a degree of similarity between the first concept information and the second concept information.

According to another aspect of the present disclosure, a computer-readable storage medium storing a program reflecting one aspect of the present disclosure includes a program that causes a hardware processor in a computer to:
acquire first concept information including a concept of an image desired by a user, generate a predetermined number of sheets of image data by inputting the acquired first concept information to a first generative AI model that generates the image data based on the concept information, generate second concept information by inputting the generated image data in a second generative AI model that generates the concept based on the image data, and evaluate, for each image data, a degree of similarity between the first concept information and the second concept information.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a block diagram illustrating an image generating system according to an embodiment of the present disclosure;

FIG. 2 is a block diagram illustrating a functional configuration of a server;

FIG. 3 is a block diagram illustrating a functional configuration of a terminal device;

FIG. 4 is a flowchart illustrating image providing processing;

FIG. 5 is a diagram illustrating a second image and a heat map image;

FIG. 6 is a radar chart of an impression;

FIG. 7 is a flowchart illustrating image providing processing;

FIG. 8 is a flowchart illustrating concept evaluation processing;

FIG. 9 is a view illustrating a display screen;

FIG. 10 is a diagram illustrating a first image, first concept information, a second image, and second concept information according to a first example;

FIG. 11 is a diagram illustrating first concept information, a second image, and second concept information of a second example; and

FIG. 12 is a diagram illustrating an example of information exchanged between an AI providing device and the server.

### DETAILED DESCRIPTION

Hereinafter, one or more embodiments of the present disclosure will be described with reference to the drawings. However, the scope of the invention is not limited to the disclosed embodiments.

Advantages and features provided by one or more embodiments of the present disclosure will be more fully understood from the following detailed description and the accompanying drawings. However, these drawings are for illustration purposes only. Therefore, it is not intended to define the limits of the present disclosure. Hereinafter, embodiments of the present disclosure will be described with reference to the drawings. However, the scope of the present disclosure is not limited to the disclosed embodiment.

### First Embodiment

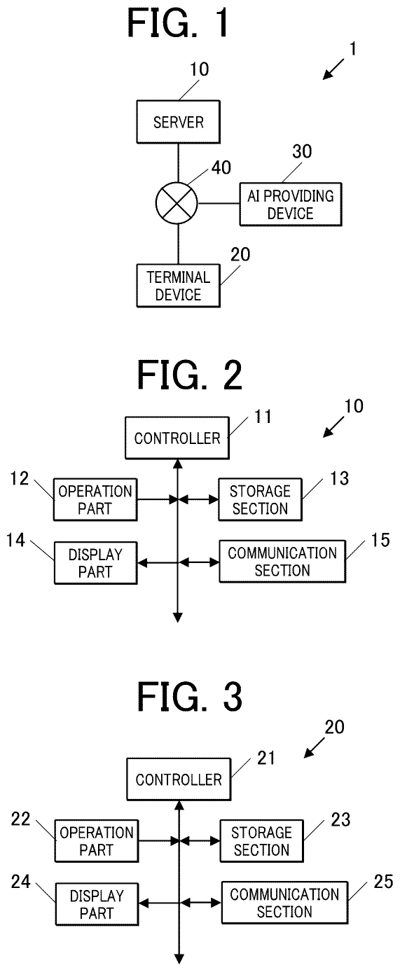

A first embodiment according to the present disclosure will be described with reference to FIG. 1 to FIG. 6. First, a device configuration of an image generating system 1 according to the present embodiment will be described with reference to FIG. 1 to FIG. 3. FIG. 1 illustrates a block diagram illustrating an image generating system 1 according to the present embodiment. FIG. 2 is a block diagram illustrating a functional configuration of a server 10. FIG. 3 is a block diagram illustrating a functional configuration of a terminal device 20.

As illustrated in FIG. 1, the image generating system 1 is a system that generates image data of a concept intended by a user. The image generating system 1 includes a server 10, a terminal device 20, and an artificial intelligence (AI) providing device 30 (provider). The AI providing device 30 functions as a providing section. The server 10, the terminal device 20, and the AI providing device 30 are communicably connected to each other via a communication network 40. The communication network 40 is, for example, the Internet, but is not limited thereto. The communication network 40 may be another communication network for wired communication or wireless communication, such as a local area network (LAN) or the like.

The server 10 is an information processing apparatus that provides the image data of a concept intended by a user to the terminal device 20. The terminal device 20 is a desktop personal computer (PC) used by a user. The terminal device 20 is not limited to a desktop PC, but may be any other information processing apparatus such as a palmtop PC or a smartphone.

The AI providing device 30 is an information processing apparatus that provides a generative AI model to an external device such as the server 10. The generative AI model is a so-called trained model of an image generating AI. The generative AI model automatically generates the image data when a prompt is input. The generated image data is the image data close to concept information of the input prompt. The prompt is text in a natural language that describes a task for the generative AI to perform. The prompt includes concept information mainly indicating an idea or atmosphere of a completed form intended by the user. The concept information includes at least one concept for the image in the completed form intended by the user.

The AI providing device 30 receives, for example, the prompt from the server 10. The AI providing device 30 inputs a prompt to the generative AI model and generates the image data close to the concept information. The AI providing device 30 transmits the generated image data to the server 10 that is a transmission source of the prompt.

Next, an internal functional configuration of the server 10 will be described with reference to FIG. 2. As illustrated in FIG. 2, the server 10 includes a controller 11 (hardware processor), an operation part 12 (operator), a storage section 13, a display part 14, and a communication section 15. The respective units of the server 10 are connected to each other via a bus. The controller 11 functions as an acquisition section, a generation control section, an evaluation section, a selection section, and a display control section.

The controller 11 controls each part of the server 10. The controller 11 includes a central processing unit (CPU) and a random access memory (RAM). The controller 11 reads various programs stored in the storage section 13, deploys the various programs to the RAM, and performs various types of processing in accordance with the deployed various programs and the CPU.

The operation part 12 includes a keyboard and a pointing device such as a mouse. The operation part 12 accepts input through the keys and positions input from the user, and outputs such operation information to the controller 11.

The storage section 13 is a hard disk drive (HDD), a solid state drive (SSD), or the like. The storage section 13 stores information such as data in a readable and writable manner. In particular, the storage section 13 stores an image providing program. The image providing program is a program for executing image providing processing to be described later.

The display part 14 includes a display panel such as a liquid crystal display (LCD) and an electro-luminescent display (ELD). Under the control of the controller 11, the display part 14 displays display information on the display panel.

The communication section 15 is a communication module such as a network card, and performs wired communication or wireless communication with external devices such as the terminal device 20 and the AI providing device 30 on the communication network 40. The controller 11 transmits and receives information to and from the terminal device 20, the AI providing device 30, and the like through the communication section 15.

Next, an internal functional configuration of the terminal device 20 will be described with reference to FIG. 3. As illustrated in FIG. 3, the terminal device 20 includes a controller 21, an operation part 22, a storage section 23, a display part 24, and a communication section 25. The respective units of the terminal device 20 are connected to each other via a bus.

The controller 21 controls each unit of the terminal device 20. The controller 21 includes a CPU and a RAM. The controller 21 reads various programs stored in the storage section 23, deploys the various programs to the RAM, and performs various types of processing in accordance with the deployed various programs and the CPU.

The operation part 22 includes a keyboard and a pointing device such as a mouse. The operation part 22 accepts input through the keys and positions input from the user, and outputs such operation information to the controller 21.

The storage section 23 is an HDD, an SSD, or the like. The storage section 23 stores various types of information in a readable and writable manner.

The display part 24 includes a display panel such as an LCD and an ELD. The display part 24 displays display information on the display panel under the control of the controller 21.

The communication section 25 is a communication module such as a network card, and performs wired communication or wireless communication with an external device such as the server 10 on the communication network 40. The controller 21 transmits and receives information to and from the server 10 or the like through the communication section 25.

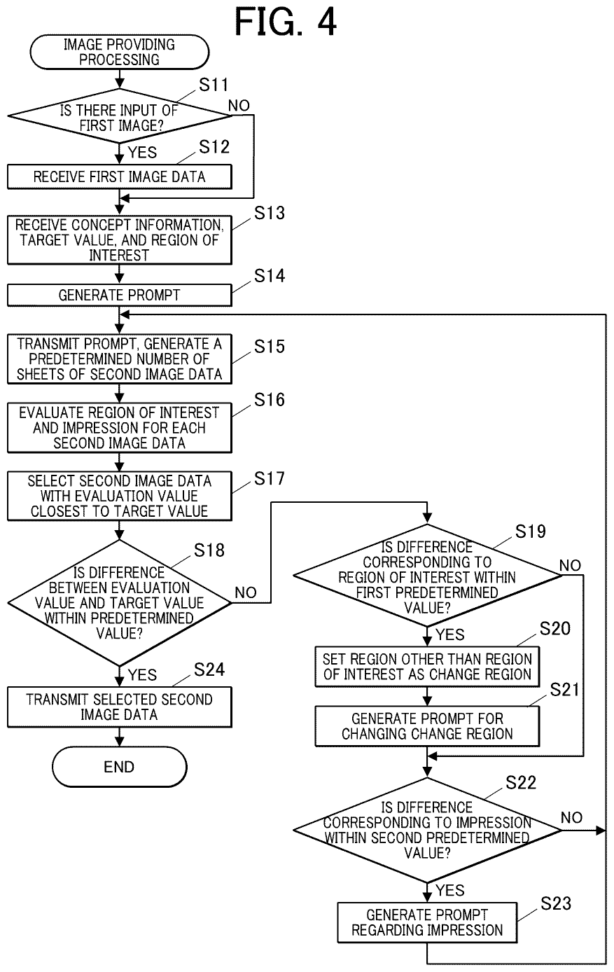

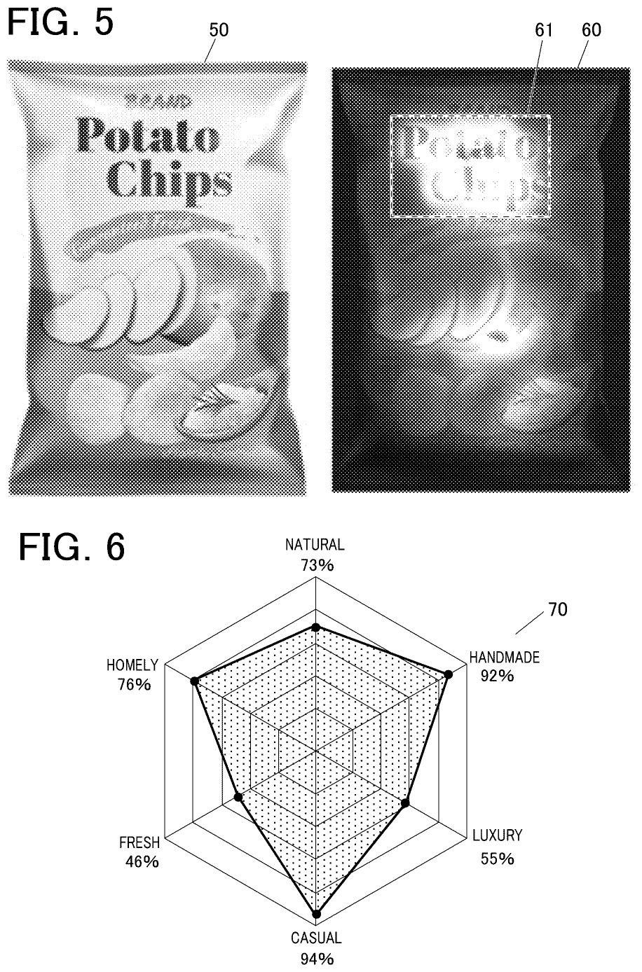

Next, with reference to FIG. 4 to FIG. 6, operation of the image generating system 1 will be described. FIG. 4 is a flowchart illustrating image providing processing. FIG. 5 is a diagram illustrating a second image 50 and a heat map image 60. FIG. 6 is a radar chart 70 of an impression.

The image providing processing executed by the server 10 will be described with reference to FIG. 4. The image providing processing is processing of generating second image data close to a concept intended by the user or the concept and first image data intended by the user, and providing the second image data to the terminal device 20. First, the controller 21 of the terminal device 20 accepts input of concept information and a target value, or the concept information, the target value, and first image data from the user via the operation part 22. The concept information is text including the concept of the image (design) of the second image data desired to be generated. For example, when the user desires the image data of an advertisement image, the concept information includes a concept of the idea or atmosphere of the completed form which the user desires to include in the advertisement image. The first image data is draft image data including image elements (a keyword, an article, a background, and the like) desired to be included in the idea of the completed form. The first image data is, for example, stored in the storage section 23 and selected and input.

The target value is a target value of an evaluation value of the second image data to be generated. The evaluation of the second image data is, for example, evaluation of a region of interest in the image or evaluation of an impression. With respect to the region of interest, the entire image of the second image data is subjected to image analysis, and a degree of attention of each pixel obtained is indicated by a heat map. For example, in a case where the second image data of a second image 50 illustrated in FIG. 5 is generated, when the second image data is subjected to the image analysis, a heat map image 60 is generated. The heat map image 60 includes pixels colored in corresponding colors as the degree of attention increases (blue to light blue to green to yellow to red (black to gray to white in the drawing)).

The region of interest is a region in the image of the second image data where the user desires to draw interest (attention), and is specified by the user. For example, in a case where the interest is to be drawn to the region in which a keyword is displayed in the image, the region of interest of a target value is the region enclosing and including the keyword. To be specific, a rectangular region of interest 61 enclosing the keyword “Potato Chips” in the heat map image 60 is selected. The evaluation value of a degree of attention of a region of interest 61 is, for example, a pixel ratio [%] of red and yellow with respect to all pixels in the region of interest 61, for example. The target value of the evaluation value of the region of interest is specified by, for example, the keyword+a predetermined value [%] that is a target of the evaluation value of the region of interest. The designation of the region of interest is not limited to the keyword, but may be coordinate information or the like of the region of interest in the second image data.

In the evaluation of the impression, an evaluation value of the impression obtained by the image analysis of the second image data is calculated. The impression includes, for example, a plurality of impression items. As shown in FIG. 6, for example, a radar chart 70 of impressions includes impression items such as “natural”, “handmade”, “luxury”, “casual”, “fresh”, and “homely”. In the evaluation value of the impression, the degree of the impression is expressed in percentage for each impression item. However, the type and the number of impression items and the way of expressing the degree of impression are not limited thereto. The target value of the evaluation value of the impression is specified by, for example, the impression item+the predetermined value [%] that is the target of the evaluation value of the impression item. The target value of the impression is not limited thereto, and may be coordinate information of the region of interest in the image or the like.

The controller 21 transmits the concept information, target value, and region of interest, or the concept information, target value, and first image data that are input to the server 10 via the communication section 25. The controller 11 of the server 10 starts receiving the concept information, target value, and region of interest, or the concept information, target value, and first image data that are input from the terminal device 20 via the communication section 15. Triggered by the start of reception, the controller 11 executes the image providing processing in accordance with an image providing program stored in the storage section 13.

First, the controller 11 determines whether reception of the first image data has started (step S11). When the reception of the first image data has started (step S11; YES), the controller 11 completes the reception of the first image data (step S12). The controller 11 completes the reception of the concept information and the target value (step S13). When the reception of the first image data has not started (step S11; NO), the process proceeds to step S13.

The controller 11 generates the prompt including the concept information of step S13 or the concept information of step S13 and the image data of step S12 (step S14). The prompt may include at least a part of the target value and the number of sheets of the second image data to be generated (a predetermined number of sheets in step S15 described later). The controller 11 transmits a prompt for step S14, S21, or S22 to the AI providing device 30 for the generative AI model via the communication section 15 (step S15). The AI providing device 30 receives the prompt for step S14, S21, or S22 from the server 10. The AI providing device 30 inputs the prompt of step S14, S21, or S22 to the generative AI model to generate a predetermined number of sheets of second image data. The AI providing device 30 transmits the generated second image data of the predetermined number of sheets to the server 10. In step S15, the controller 11 receives the generated second image data including the predetermined number of sheets from the AI providing device 30 via the communication section 15.

The controller 11 evaluates the region of interest and the impression for each of the generated second image data (step S16). In step S16, the controller 11 performs the image analysis on the image of the second image data, and calculates, as an evaluation result, the evaluation value of the region of interest included in the target value in step S13. Specifically, the controller 11 quantifies the degree of conspicuousness (degree of attention) for each pixel of the image of the second image data (saliency mapping processing). The saliency mapping processing is image processing in which each pixel included in the image is represented by a value (saliency score value) indicating the degree of conspicuousness of the pixel portion. Specifically, in the saliency mapping processing, a portion having color contrast in each of a red-green direction and a yellow-blue direction, a portion having luminance contrast, and a portion having a straight line component (edge) matching a predetermined direction are indicated as conspicuous portions (portions easily recognizable by sight) with high numeric values. The predetermined direction is, for example, a direction from 0 degrees to 315 degree in increments of 45 degrees when the angle is taken from 0 degrees to 360 degrees.

The presence of the color contrast in the red-green direction corresponds to, for example, the difference in value indicating color in the red-green direction between adjacent pixels being equal to or greater than a predetermined value. The presence of the color contrast in the yellow-blue direction corresponds to, for example, the difference in value indicating color in the yellow-blue direction between adjacent pixels being equal to or greater than a predetermined value. The presence of luminance contrast corresponds to, for example, the difference in value indicating luminance between adjacent pixels being equal to or greater than a predetermined value. Further, among the angles indicating a predetermined direction, 0 degrees and 180 degrees (horizontal direction), 45 degrees and 225 degrees (direction upward diagonal to the right), 90 degrees and 270 degrees (vertical direction), and 135 degrees and 315 degrees (direction downward diagonal to the right), each correspond to a linear component in the same direction. The controller 11 generates the heat map image in which the image of the second image data is converted into pixels in colors corresponding to the quantified degrees of attention. The controller 11 sets the ratio of red and yellow pixels to all pixels of the region of interest in the heat map image as the evaluation value of the region of interest.

Furthermore, in step S16, the controller 11 performs image analysis on the image of the second image data, and calculates an evaluation value of the impression of the image as the evaluation result. Specifically, the controller 11 performs color reduction processing of collecting colors similar to each other into the same color for the colors of the pixels constituting the image of the second image data. The controller 11 obtains a ratio (area ratio) that each of the plurality of combined colors (color arrangement patterns) covers in the image. The controller 11 calculates a similarity between the color arrangement pattern of the image of the second image data and the color arrangement pattern of the impression correspondence table (not illustrated).

In the impression correspondence table, an impression word indicating an impression given by the image is associated with a combination of a plurality of colors (for example, three colors) as a feature amount of the image. The impression words are, for example, “natural”, “handmade”, “luxury”, “casual”, “fresh”, and “homely”. Each color is indicated by RGB gradation values. In the impression correspondence table, a feature amount other than the color may be included as the feature amount of the image associated with each impression word. The impression correspondence table is, for example, generated in advance and stored in the storage section 13. The controller 11 estimates the impression word corresponding to the color arrangement pattern as the impression item of the image of the second image data, together with the evaluation value (impression degree) [%] corresponding to the similarity.

Here, a case of using the impression correspondence table is described, but a correlation formula created on the basis of a correspondence relationship between the impression words of sample images and feature amounts of the sample images may be used. Alternatively, a trained model of machine learning may be used. Such trained model is learned with, as training data, the feature amount of each of a plurality of sample images, and the impression word and the impression degree of each of the sample images evaluated by a plurality of subjects. When the image data is input, the trained model outputs the impression word and the impression degree corresponding to the image of the image data.

The controller 11 selects, from the predetermined number of sheets of the second image data, the second image data in which the evaluation result of the region of interest in step S16 and the evaluation result of the impression are closest to the target value (step S17). In step S17, for example, one sheet of the second image data having the smallest total value of the difference of the evaluation value from the target value in the region of interest and the difference of the evaluation value from the target value in the impression is selected. However, the selection method is not limited to this.

The controller 11 determines whether or not the difference between the evaluation value and the target value of the region of interest is equal to or within a first predetermined value and the difference between the evaluation value and the target value of the impression is equal to or within a second predetermined value (step S18). The first predetermined value is a threshold value of an allowable difference of the evaluation value with respect to the target value of the region of interest. The second predetermined value is a threshold value of the allowable difference of the evaluation value with respect to the target value of the impression. If it is not a case in which the difference between the evaluation value and the target value of the region of interest is equal to or within the first predetermined value and the difference between the evaluation value and the target value of the impression is within the second predetermined value (step S18; NO), the process proceeds to step S19.

The controller 11 determines whether or not the difference between the evaluation value and the target value in the region of interest is equal to or within the first predetermined value (step S19). If it is equal to or within the first predetermined value (step S19; YES), the process proceeds to step S20. The controller 11 sets, as a change region, a region other than the region of interest in the image of the second image data (step S20). The change region is a region to be changed when new second image data is generated based on the image of the second image data selected in step S17. The controller 11 generates a prompt for changing (correcting) the set change region (step S21). The prompt generated in step S21 includes the second image data selected in step S17 and a text indicating that the change region is to be changed. The processing proceeds to step S15.

The controller 11 determines whether or not a difference between the evaluation value and the target value of the impression is equal to or within a second predetermined value (step S22). If the difference is not equal to or within the first predetermined value (step S19; NO), the process proceeds to step S22. If it is equal to or within the second predetermined value (step S22; YES), the controller 11 generates the (correction) prompt related to the impression (step S23). The prompt generated in step S23 includes, for example, a text for generating the second image data for increasing the evaluation value of the impression item of the target value. The processing proceeds to step S15. If it is not equal to or within the second predetermined value (step S22; NO), the process proceeds to step S15.

In a case where the difference of the evaluation value with respect to the target value of the region of interest is equal to or within the first predetermined value and the difference of the evaluation value with respect to the target value of the impression is equal to or within the second predetermined value (step S18; YES), the process proceeds to step S24. The controller 11 sends the second image data selected in step S17 to the terminal device 20 via the communication section 15 (step S24). The controller 21 of the terminal device 20 receives the second image data from the server 10 via the communication section 25, and displays the second image data on the display part 24. The image providing processing ends.

Note that the number of second image data selected in step S17 and transmitted and displayed in step S24 is not limited to one sheet, and may be a plurality of sheets such that the evaluation value is closer to the target value. For example, when there are a plurality of second image data satisfying the condition of step S18, the plurality of second image data may be selected, transmitted, and displayed.

Here, a specific example of the image providing processing will be described with reference to FIG. 5 and FIG. 6. The user prepares first image data of a front image of potato chips including the keyword “Potato Chips”. The user desires the second image data based on the first image and having the design friendly to men and women from 10 to those in their 20's. In advance, in the terminal device 20, the target value of the region of interest and the target value of the impression are input by operation from the user together with the desired concept information. The target value of the region of interest is to be as follows, the target value of the region of interest: the region of interest of the keyword “Potato Chips”+AA [%]. The target value of the impression is 95% for the impression item “casual”+95% for the impression item “fresh”.

In step S14 of the image providing processing, the prompt is generated. The prompt is, for example, the following text (1).
(1) This is the design of a product package. Make your design friendly to men and women from 10 to those in their 20's. Make your design casual and hand-made-like. Create 100 sheets of the second image data.

In step S15, 100 sheets of the second image data are generated. In step S16, the evaluation value of the region of interest in the image of each sheet of the second image data and the evaluation value of the impression are calculated. In step S17, the second image data of 1 sheet of the second image 50 is selected. The evaluation value of the region of interest in the second image data of the second image 50 is, for example, the ratio (AA-α) [%] of red and yellow pixels in the region of interest 61 in the heat map image 60. The evaluation value of the impression in the second image data of the second image 50 is, for example, a numerical value [%] of each impression item in the radar chart 70 of the impression.

In step S18, it is assumed that the first predetermined value is, for example, β(β<α) [%]. In this case, the difference between the evaluation value (AA-α) [%] of the region of interest 61 and the target value AA is not equal to or within the first predetermined value. In step S21, the prompt including the second image data of the second image 50 and the following text (2) is generated.
(2) Create 100 sheets of the second image data with an image other than the region of interest of the image 50 as a change (modification) target.

Alternatively, it is assumed that the first predetermined value is, for example, β (β>α) [%] in step S18. In this case, the difference between the evaluation value (AA-α) [%] of the region of interest 61 and the target value AA is equal to or within the first predetermined value. Here, it is assumed that the second predetermined value is, for example, 5 [%]. In this case, the difference between the evaluation value (“casual” 95%, “fresh” 95%) and the target value (“casual” 94%, “fresh” 46%) of the impression is not equal to or within the second predetermined value. In steps S18 and S19, for example, a difference between the average values of the impression degrees in the impression items “casual” and “fresh” is compared with the second predetermined value. In step S22, for example, the impression degree in each of the impression items “casual” and “fresh” is compared with the target value, and a comparison result is also reflected in the prompt. Thus, the prompt including the text of the following (3) is generated.
(3) Make the design so that the fresh impression is stronger. For the casual impression, maintain the current state. Create 100 sheets of such second image data.

According to the present embodiment described above, the image generating system 1 includes the controller 11. The controller 11 acquires the concept information including the concept of the image desired by the user and the target value for the evaluation value of the image data from the terminal device 20. The controller 11 causes the generative AI model to generate the plurality of the second image data on the basis of the prompt corresponding to the acquired concept information. The controller 11 evaluates each of the generated image data. The controller 11 selects one of the second image data whose evaluated evaluation value is closer to the target value. Therefore, the second image data desired by the user can be easily generated from the concept of the image.

The controller 11 transmits the selected second image data to the display part 24 to be displayed. Therefore, the user can visually confirm the generated second image data.

The controller 11 acquires the first image data of the draft image, the concept information, and the target value. Based on the acquired first image data and the prompt corresponding to the concept information, the controller 11 causes the generative AI model to generate the plurality of second image data. Therefore, the second image data desired by the user can be easily generated from the concept of the first image data and the image data.

Based on the selected second image data, the evaluation value, and the target value, the controller 11 generates a new prompt for causing the evaluation value to further approach the target value. The controller 11 inputs the new modified prompt to the generative AI model. Therefore, the second image data desired by the user can be easily and accurately generated.

The controller 11 repeats generation of the new prompt and generation of the second image data based on the new prompt until the evaluation value falls equal to or within the predetermined value from the target value. Therefore, the second image data desired by the user can be generated easily and more accurately.

The evaluation is evaluation of the impression in the image in the generated second image data and the degree of attention of the region of interest. The controller 11 generates the new prompt such that the evaluation value of the impression is within the second predetermined value from the target value. Therefore, the second image data having an impression desired by the user can be easily generated from the new prompt.

When the evaluation value of the attention degree of the region of interest is within the first predetermined value, the controller 11 generates the new prompt so as to change the region other than the region of interest. Therefore, the second image data with the attention degree of the region of interest desired by the user can be easily generated from the new prompt.

The image generating system 1 includes the AI providing device 30 that provides the generative AI model. Therefore, the processing load on the server 10 can be reduced.

Although an example in which the storage section (HDD or SSD) is used as a computer-readable medium for the program according to the present disclosure has been disclosed in the above description, the medium is not limited to this example. As other computer-readable media, a nonvolatile memory such as a flash memory and a portable storage medium such as a CD-ROM can be applied. Furthermore, a carrier wave is also applied to the present disclosure as a medium that provides data of the program according to the present disclosure via a communication line.

Note that the description in the above-described first embodiment is one example of the image generating system, the image generating method, and the program according to the present disclosure and is not limited thereto.

Furthermore, although the AI providing device 30 is configured to provide the generative AI in the first embodiment described above, it is not limited thereto. The server 10 itself may have the function of providing the generative AI.

Furthermore, in the first embodiment described above, the number of sheets of the second image data to be generated in step S15 is a predetermined number of sheets set in advance, but it is not limited thereto. For example, when the controller 21 accepts input of the concept information from the user via the operation part 22, the controller 21 may accept input of the setting in the concept information including the number of sheets of the image data to be generated. The number of sheets of the image data to be generated input on the terminal device 20 is transmitted to the server 10. The controller 11 of the server 10 sets the predetermined number of sheets of the received image data as the predetermined number of sheets of step S15 in the image providing processing. That is, the predetermined number of sheets of the image data is the number of sheets input by operation from the user via the operation part 22. Therefore, the user can specify the number of sheets of the image data to be generated. The predetermined number of sheets can be increased to increase the completeness of the second image data for a desired concept. Alternatively, the amount of time required to generate the second image data can be shortened by reducing the predetermined number of sheets of image data.

### Second Embodiment

A second embodiment of the present disclosure will be described with reference to FIG. 1 to FIG. 3 and FIG. 7 to FIG. 11. First, a device configuration of an image generating system 1 according to the present embodiment will be described with reference to FIG. 1 to FIG. 3. FIG. 1 illustrates a block diagram illustrating an image generating system 1 according to the present embodiment. FIG. 2 is a block diagram illustrating a functional configuration of a server 10. FIG. 3 is a block diagram illustrating a functional configuration of a terminal device 20.

As illustrated in FIG. 1, the image generating system 1 is a system that generates image data of a concept intended by a user. The image generating system 1 includes a server 10, a terminal device 20, and an AI providing device 30. The AI providing device 30 functions as a first providing section and a second providing section. The server 10, the terminal device 20, and the AI providing device 30 are communicably connected to each other via a communication network 40. The communication network 40 is, for example, the Internet, but is not limited thereto. The communication network 40 may be another communication network for wired communication or wireless communication, such as a local area network (LAN) or the like.

The server 10 is an information processing apparatus that provides the image data of a concept intended by a user to the terminal device 20. The terminal device 20 is a desktop personal computer (PC) used by a user. The terminal device 20 is not limited to a desktop PC, but may be any other information processing apparatus such as a palmtop PC or a smartphone.

The AI providing device 30 is an information processing apparatus that provides a first generative AI model and a second generative AI model to an external device such as the server 10. The first generative AI model is a so-called trained model of an image generating AI. The first generative AI model automatically generates the image data when a first prompt is input. The generated image data is the image data close to first concept information of the input prompt. The prompt is text in a natural language that describes a task for the generative AI to perform. The first prompt includes first concept information mainly indicating an idea or atmosphere of a completed form intended by the user. The first concept information includes at least one concept for the image in the completed form intended by the user. The first prompt includes a description of a task for generating the image data that satisfies the first concept information (and article information of an article included in the idea of the completed form).

The second generative AI model is a trained model that generates second concept information of a text in response to input of the image data and a second prompt. The second concept information includes a concept analyzed from the image of the image data. The second prompt includes text of a routine task that causes the second generative AI model to generate the second concept information.

The AI providing device 30 receives, for example, the first prompt from the server 10. The AI providing device 30 inputs the first prompt to the first generative AI model and generates the image data close to the first concept information. The AI providing device 30 transmits the generated image data to the server 10 that is a transmission source of the first prompt. Further, when receiving the image data from the server 10, the AI providing device 30 inputs the image data to the second generative AI model, and generates the second concept information satisfying the image data. The AI providing device 30 transmits the generated second concept information to the server 10 which is the transmission source of the image data.

Next, an internal functional configuration of the server 10 will be described with reference to FIG. 2. As illustrated in FIG. 2, the server 10 includes a controller 11, an operation part 12, a storage section 13, a display part 14, and a communication section 15. The respective units of the server 10 are connected to each other via a bus. The controller 11 functions as an acquisition section, a first generation control section, a second generation control section, an evaluation section, and a display control section.

The controller 11 controls each part of the server 10. The controller 11 includes a central processing unit (CPU) and a random access memory (RAM). The controller 11 reads various programs stored in the storage section 13, deploys the various programs to the RAM, and performs various types of processing in accordance with the deployed various programs and the CPU.

The operation part 12 includes a keyboard and a pointing device such as a mouse. The operation part 12 accepts input through the keys and positions input from the user, and outputs such operation information to the controller 11.

The storage section 13 is a hard disk drive (HDD), a solid state drive (SSD), or the like. The storage section 13 stores information such as data in a readable and writable manner. In particular, the storage section 13 stores an image providing program. The image providing program is a program for executing image providing processing to be described later. The storage section 13 also stores a synonym database. The synonym database is data of a synonym dictionary and includes synonyms having meanings similar to those of any term. The synonym database is used for evaluating the similarity between the concept of the first concept information and the concept of the second concept information. Furthermore, the synonym database may include, together with the term and synonyms thereof, information on a degree (extent) of similarity among the synonyms. With this configuration, evaluation of similarity can be subdivided.

The display part 14 includes a display panel such as a liquid crystal display (LCD) and an electro-luminescent display (ELD). Under the control of the controller 11, the display part 14 displays display information on the display panel.

The communication section 15 is a communication module such as a network card, and performs wired communication or wireless communication with external devices such as the terminal device 20 and the AI providing device 30 on the communication network 40. The controller 11 transmits and receives information to and from the terminal device 20, the AI providing device 30, and the like through the communication section 15.

Next, an internal functional configuration of the terminal device 20 will be described with reference to FIG. 3. As illustrated in FIG. 3, the terminal device 20 includes a controller 21, an operation part 22, a storage section 23, a display part 24, and a communication section 25. The respective units of the terminal device 20 are connected to each other via a bus.

The controller 21 controls each unit of the terminal device 20. The controller 21 includes a CPU and a RAM. The controller 21 reads various programs stored in the storage section 23, deploys the various programs to the RAM, and performs various types of processing in accordance with the deployed various programs and the CPU.

The operation part 22 includes a keyboard and a pointing device such as a mouse. The operation part 22 accepts input through the keys and positions input from the user, and outputs such operation information to the controller 21.

The storage section 23 is an HDD, an SSD, or the like. The storage section 23 stores various types of information in a readable and writable manner.

The display part 24 includes a display panel such as an LCD and an ELD. The display part 24 displays display information on the display panel under the control of the controller 21.

The communication section 25 is a communication module such as a network card, and performs wired communication or wireless communication with an external device such as the server 10 on the communication network 40. The controller 21 transmits and receives information to and from the server 10 or the like through the communication section 25.

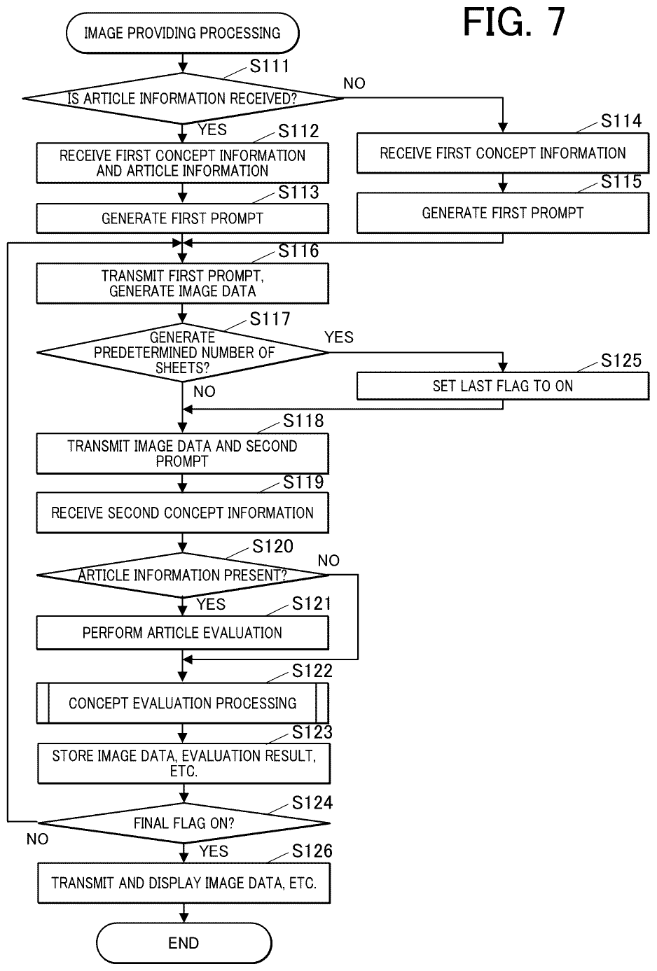

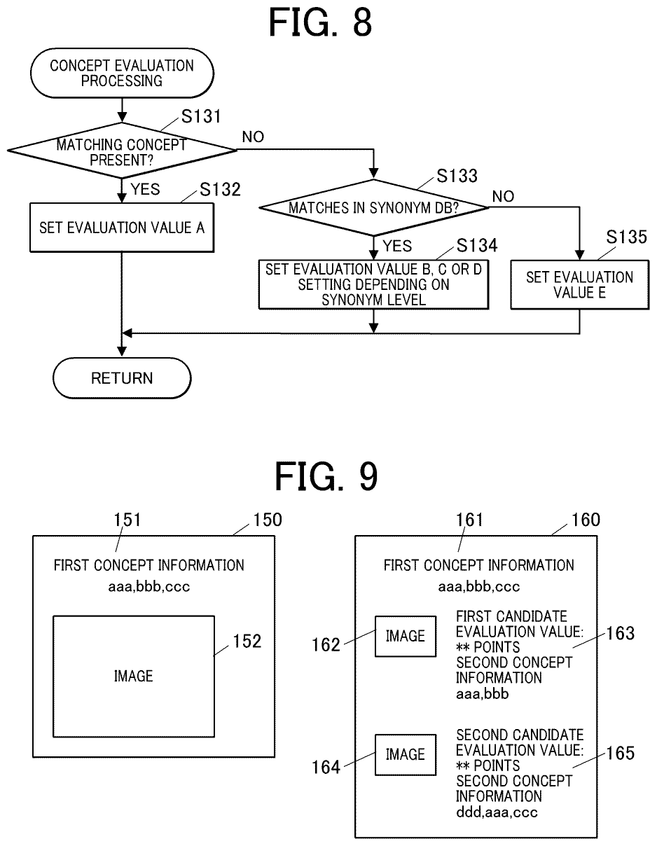

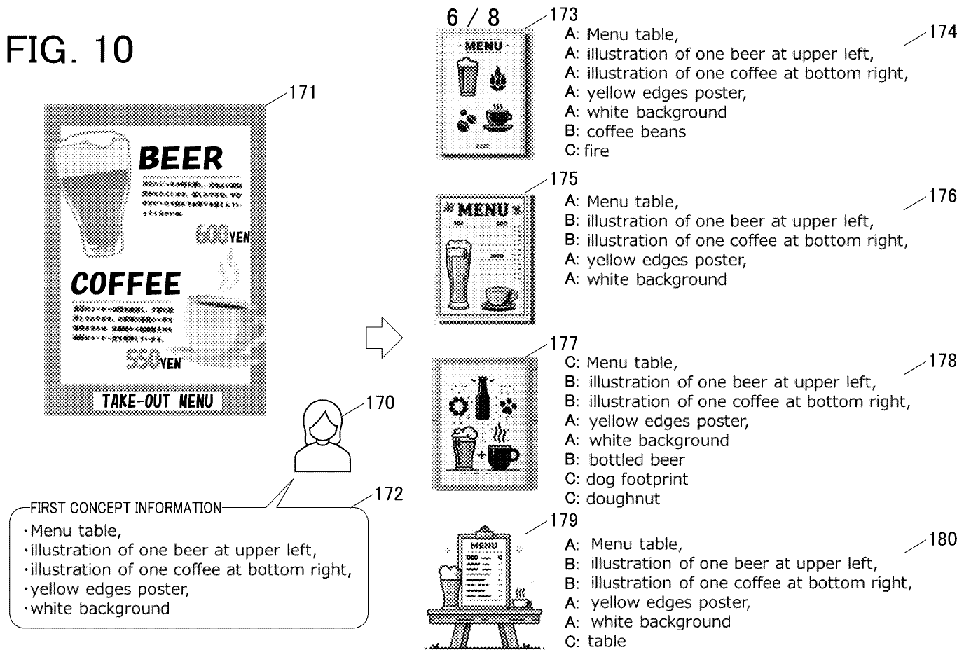

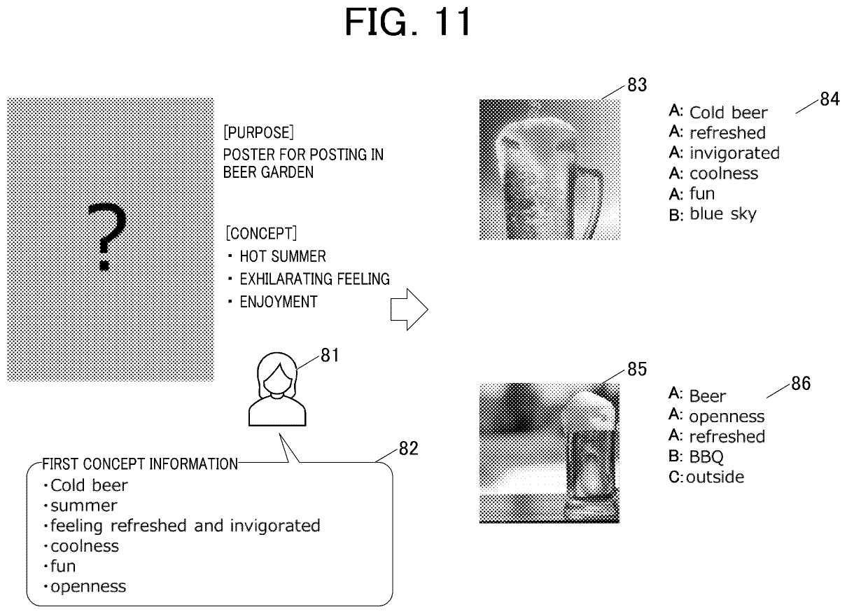

Next, with reference to FIG. 7 to FIG. 11, operation of the image generating system 1 will be described. FIG. 7 is a flowchart illustrating image providing processing. FIG. 8 is a flowchart illustrating concept evaluation processing. FIG. 9 is a diagram illustrating display screens 150 and 160. FIG. 10 is a diagram illustrating the first image 171, the first concept information 172, the second images 173, 175, 177, and 179, and the second concept information 174, 176, 178, and 180 of the first example. FIG. 11 is a diagram illustrating the first concept information 82, the second images 83 and 85, and the second concept information 84 and 86 of the second example.

The image providing processing executed by the server 10 will be described with reference to FIG. 7. The image providing processing is processing of generating image data close to a concept intended by the user or the concept and article information intended by the user, and providing the image data to the terminal device 20. First, the controller 21 of the terminal device 20 accepts input of the first concept information or the first concept information and the article information from the user via the operation part 22. The first concept information is text including the concept for the image of the image data desired to be generated. The article information is the text of the article as an image element that is desired to be included in the idea in the completed form. For example, when the user desires the image data of an advertisement image, the first concept information includes the concept of the idea or atmosphere of the completed form which the user desires to include in the advertisement image. However, the article information may be information of another image element such as a scene other than the article included in the idea of the completed form.

The controller 21 transmits the first concept information or the first concept information and the article information that are input to the server 10 via the communication section 25. The controller 11 of the server 10 starts receiving the first concept information or the first concept information and the article information that are input from the terminal device 20 via the communication section 15. Triggered by the start of reception, the controller 11 executes the image providing processing in accordance with an image providing program stored in the storage section 13.

First, the controller 11 determines whether reception of the article information has started (step S111). When the reception of the article information has started (step S111; YES), the controller 11 completes the reception of the first concept information and the article information (step S112). The controller 11 generates a first prompt including the first concept information and the article information received in step S112 (step S113). The first concept information and the article information are stored in, for example, the storage section 13.

When the input of the article information has not started (step S111; NO), the controller 11 completes the reception of the first concept information (step S114). The controller 11 generates a first prompt including the first concept information received in step S114 (step S115). The controller 11 transmits the first prompt to the AI providing device 30 for the first generative AI model via the communication section 15 (step S116). The AI providing device 30 receives the first prompt of step S113 or step S115 from the server 10. The AI providing device 30 inputs the first prompt of step S113 or step S115 to the first generative AI model and generates the one sheet of image data. The AI providing device 30 transmits the generated one sheet of image data to the server 10. In step S116, the controller 11 receives the generated one sheet of image data from the AI providing device 30 via the communication section 15.

The controller 11 determines whether the predetermined number of sheets of image data have been generated in step S116 since a start of image generating processing (step S117). The predetermined number of sheets is a preset number of generated sheets of the image data to be generated in the image providing processing. The predetermined number of sheets is stored in advance in the storage section 13, for example. The predetermined number of sheets may be included in the first prompt of step S115. When the predetermined number of sheets have not been generated (step S117; NO), the controller 11 generates a second prompt (step S118). The second prompt is a prompt for the second generative AI model. The second prompt is, for example, a routine prompt that is stored in advance in the storage section 13 and is used to obtain the second concept information from the image data. In step S118, the image data and the second prompt are transmitted to the AI providing device 30 for the second generative AI model via the communication section 15.

The AI providing device 30 receives the image data and the second prompt transmitted in step S118 from the server 10. The AI providing device 30 inputs the image data and the second prompt of step S118 to the second generative AI model to generate the second concept information. The second concept information is text of the concept representing the image of the image data. The AI providing device 30 transmits the generated second concept information to the server 10. The controller 11 receives the generated second concept information from the AI providing device 30 via the communication section 15 (step S119).

The controller 11 determines whether or not there is article information received in step S112 (step S120). If there is element information (step S120; YES), the controller 11 analyzes the image of the image data received in step S116 and acquires the article information of the included article (step S121). In step S121, the controller 11 compares the analyzed article information with the article information input in step S112, and performs article evaluation that evaluates matching (similarity). The article evaluation calculates, for example, as an evaluation result, an evaluation value that increases as the degree of similarity of the article information increases. The second generative AI may include a function of analyzing the image of the article included in the image of the input image data and outputting the article information of the article. In this configuration, the second prompt in step S118 includes text requesting the article information of the second image data. In step S119, the article information of the second image data is received from the AI providing device 30 together with the second concept information. In step S121, the article information in step S119 and the article information in step S112 are compared with each other, and the evaluation result of the article evaluation is generated. For the article evaluation, a synonym database is used, or an LLM (Large Language Models: A large scale language model) may be used.

The controller 11 performs concept evaluation processing in which the second concept information is evaluated (step S122). Here, the concept evaluation processing in step S122 will be described with reference to FIG. 8. The controller 11 compares the concept included in the first information with the concept included in the second information (step S131). In step S131, the controller 11 determines, based on the comparison result, whether or not there is a completely matching concept. When there is a matching concept (step S131; YES), the controller 11 sets an evaluation value A as the evaluation result of the concept evaluation (step S132). The concept evaluation processing ends. The evaluation value A and evaluation values B, C, D, and E (described later) are, for example, numeric values. Here, it is assumed that evaluation value A>evaluation value B>evaluation value C>evaluation value D>evaluation value E.

When there is no matching concept (step S131; NO), the controller 11 refers to the synonym database stored in the storage section 13 (step S133). In step S133, the controller 11 compares the concept included in the first concept information with the synonym of the concept included in the second concept information. In step S133, the controller 11 compares the synonym of the concept included in the first concept information with the concept included in the second concept information. Furthermore, in step S133, the controller 11 may compare synonyms of the concept included in the first concept information with synonyms of the concept included in the second concept information. In the synonym database, each synonym is associated with synonym levels L1 to L3 indicating a degree (extent) of similarity. In step S133, the controller 11 determines, based on the comparison result, whether or not there is a matching concept.

If there is a matching concept (step S133; YES), the controller 11 refers to the synonym levels L1 to L3 of synonyms of the matching concept (step S134). In step S134, the controller 11 sets the evaluation values B to C as the evaluation result of the concept evaluation, based on the referred synonym levels L1 to L3. The concept evaluation processing ends. For example, the evaluation value B is set corresponding to the synonym level L1. The evaluation value C is set corresponding to the synonym level L2. The evaluation value D is set corresponding to the synonym level L3.

When there is no matching concept (step S133; NO), the controller 11 sets the evaluation value E as the evaluation result of the concept evaluation (step S135). The concept evaluation processing ends. Note that the evaluation value is not limited to five levels, and may be any other number of levels or a numerical value itself.

Returning to FIG. 7, when there is no element information (step S120; NO), the process proceeds to step S122. The controller 11 stores the image data of step S116, the evaluation results of the article evaluation and the concept evaluation of step S121 and step S122, and the like in the storage section 13 in association with each other (step S123). The evaluation results of the article evaluation and the concept evaluation are combined into one evaluation value, for example, as a total value of the evaluation values of the article evaluation and the concept evaluation. The information associated with the image data includes the first concept information of step S112, the first prompt of step S113 or step S115, the second prompt of step S118, and the second concept information of step S119.

The controller 11 determines whether the last flag, which indicates that a predetermined number of sheets of the image data have been generated, is on (step S124). When the last flag is off (step S124; NO), the process proceeds to step S116. When the predetermined number of sheets have been generated (step S117; YES), the controller 11 turns on the last flag (step S125). The processing proceeds to step S118.

When the last flag is ON (step S124; YES), the controller 11 reads out image data for display and the like from the storage section 13 (step S126). In step S126, the controller 11 transmits the read image data for display and the like to the terminal device 20 via the communication section 15. The controller 21 of the terminal device 20 receives image data for display and the like from the server 10 via the communication section 25, and displays the image data on the display part 14. The image providing processing ends.

Here, display screens 150 and 160 to be displayed correspondingly to step S126 will be described with reference to FIG. 9. First, in a case of displaying only image data having the highest evaluation value of the evaluation result on the terminal device 20, for example, the display screen 150 is displayed on the terminal device 20. In this case, in step S126, the controller 11 reads and refers to all the evaluation results and extracts the highest evaluation value. The controller 11 reads image data having the highest evaluation value and its first concept information from the storage section 13, and transmits the above to the terminal device 20. The controller 21 of the terminal device 20 receives the image data having the highest evaluation value and the first concept information from the server 10, generates the display screen 150, and displays the screen on the display part 14.

The display screen 150 is the display screen of the image data having the highest evaluation value of the evaluation result. The display screen 150 includes first concept information 151 and an image 152. The first concept information 151 includes, for example, three concepts “aaa”, “bbb”, and “ccc”. The image 152 is an image of image data having the highest evaluation value among a predetermined number of sheets of image data generated corresponding to the first concept information 151.

Next, when a predetermined number (plurality of) image data having the highest evaluation values of the evaluation results are to be displayed on the terminal device 20, for example, the display screen 160 is displayed on the terminal device 20. In this case, in step S126, the controller 11 reads and refers to all the evaluation results, and extracts a predetermined number of top evaluation values. The controller 11 reads the top predetermined number of image data, the first concept information, the evaluation value, and the second concept information thereof from the storage section 13 and transmits the above to the terminal device 20. The controller 21 of the terminal device 20 receives the top predetermined number of image data, the first concept information, the evaluation value, and the second concept information thereof from the server 10. The controller 21 generates the display screen 160 and displays the screen on the display part 14.

The display screen 160 is the display screen of the image data having a predetermined number (=2) of highest evaluation values. Provided that the predetermined highest number is not limited to two. The display screen 160 includes first concept information 161, image 162, image information 163, image 164, and image information 165. The first concept information 161 includes, for example, three concepts “aaa”, “bbb”, and “ccc”. The image 162 is the image of image data having the highest evaluation value among a predetermined number of sheets of image data generated corresponding to the first concept information 161. The image information 163 is text corresponding to the image data of the image 162. The image information 163 includes a title “first candidate” including a ranking (first place) of the evaluation value, the evaluation value, and the second concept information. The second concept information of the image information 163 includes, for example, two concepts “aaa” and “bbb”.

The image 164 is the image of the image data having a second highest evaluation value among a predetermined number of sheets of image data generated corresponding to the first concept information 161. The image information 165 is character information corresponding to the image data of the image 164. The image information 165 includes the title “SECOND CANDIDATE” including the ranking (second place) of the evaluation value, the evaluation value, and the second concept information. The second concept information of the image information 165 includes, for example, three concepts “ddd”, “aaa”, and “bbb”. Note that the display screen 150 (display screen 160) may include at least one of the first concept information, the second concept information, the evaluation value, the article information, the first prompt, and the second prompt corresponding to the image 152 (images 162, 164).

Next, a first example of the present embodiment will be described with reference to FIG. 10. The first example is an example in which the image data is generated using the article information and the first concept information in the image generating processing.

The user 170 has already created an idea of the intended first image 171, and the image is transmitted to the server 10. The first image 171 is a poster image for a menu of a cafe, and includes articles such as a beer mug and a coffee cup that are to be included in the second image in the completed form. Furthermore, in response to step S112, the first concept information 172 and the article information intended by the user 170 are input to the terminal device 20 and transmitted to the server 10.

Through the loop of steps S116 to S124, the image data of the second images 173, 175, 177, and 179 are generated corresponding to each step S116. Similarly, the second concept information 174, 176, 178, and 180 are generated corresponding to each step S119. The second concept information 174 corresponds to the second image 173. The second concept information 176 corresponds to the second image 175. The second concept information 178 corresponds to the second image 177. The second concept information 180 corresponds to the second image 179.

The second image 173 includes the articles “beer mug” and “coffee cup” included in the first image 171, and the evaluation value of the article evaluation of step S121 is high. The second concept information 174 includes a plurality of concepts. To the left of the respective concepts, the evaluation values A to C of the concept evaluation of step S122 corresponding to the concepts are displayed in an associated manner. Here, the evaluation value has three levels. The second image 175, 177, and 179 and the second concept information 176, 178, and 180 are the same as the second image 173 and the second concept information 174.

In the example of FIG. 10, the user himself/herself has a certain idea of the image. For example, the image data and the evaluation result can be generated even in a situation where a detailed idea is described, and it is necessary to create the image according to the details but the user does not have time to create the image.

A second example of the present embodiment will be described with reference to FIG. 11. The second example is an example in which the image data is generated using only the first concept information in the image generating processing. For the user 81, a desired image is not determined, but a purpose and a concept are determined.

In response to step S112 of the image generating processing, the first concept information 82 corresponding to the purpose and concept intended by the user 81 is input to the terminal device 20 and transmitted to the server 10.

Through the loop of steps S116 to S124, the image data of the second images 83 and 85 are generated corresponding to each step S116. Similarly, the second concept information 84, 86 is generated corresponding to each step S119. The second concept information 84 corresponds to the second image 83. The second concept information 86 corresponds to the second image 85.

The second concept information 84 includes a plurality of concepts. To the left of the respective concepts, the evaluation values A to C of the concept evaluation of step S122 corresponding to the concepts are displayed in an associated manner. The second image 85 and the second concept information 86 are similarly set and displayed as the second image 83 and the second concept information 84.

In the example of FIG. 11, the user does not have the idea for the image, but needs to create the image data. Even in this situation, the image data and the evaluation result can be generated. Since the user himself/herself does not have the ability to create an image of the described idea, it is possible to prevent the creation of image data from taking too much time.

According to the present embodiment described above, the server 10 of the image generating system 1 includes the controller 11. The controller 11 acquires the first concept information having a concept of the image desired by the user. The controller 11 generates a plurality of image data by inputting the first prompt including the acquired first concept information to the first generative AI model that generates the image data based on the concept information. The controller 11 inputs the generated image data to the second AI model that generates the concept based on the image data, to generate the second concept information. The controller 11 evaluates, for each image data, the degree of similarity between the first concept information and the second concept information. Therefore, the prompt can be easily generated, and the image data of the concept desired by the user can be appropriately and efficiently obtained according to the evaluation result.

The first generative AI model generates the image data based on element information (article information) having an image element (article) to be included in the image data to be generated and concept information. The controller 11 acquires the article information and the first concept information that the user desires. The controller 11 inputs the acquired article information and first concept information to the first generative AI model to generate a plurality of image data. The controller 11 evaluates the degree of similarity between the article information obtained from each image data and the acquired element information. Therefore, it is possible to obtain desired image data which reflects the article of the article information and the first concept information, and it is possible to evaluate whether the article information is reflected in each image data.

The controller 11 of the server 10 transmits the image data to the terminal device 20 and displays the image data on the display part 24. Therefore, the user can visually check the image data.

The controller 11 displays the image data having the highest evaluation result. Alternatively, the controller 11 displays a plurality of image data having high evaluation results and the evaluation results corresponding to the respective image data. Therefore, the user can easily confirm the image data having the highest evaluation result, or can confirm a plurality of image data having high evaluation results together with their evaluation results.

Using the synonym database, the controller 11 generates, for each image data, a higher evaluation value as the degree of similarity between concepts in the first concept information and the second concept information becomes higher. Therefore, it is possible to accurately evaluate the degree to which the second concept information of the image data is similar to the first concept information.

The predetermined number of sheets of image data is a preset number of sheets. Therefore, the user burden can be reduced.

The image generating system 1 includes the AI providing device 30 that provides the first generative AI model and the second generative AI model. Therefore, the configuration of the server 10 can be simplified.

### Third Embodiment

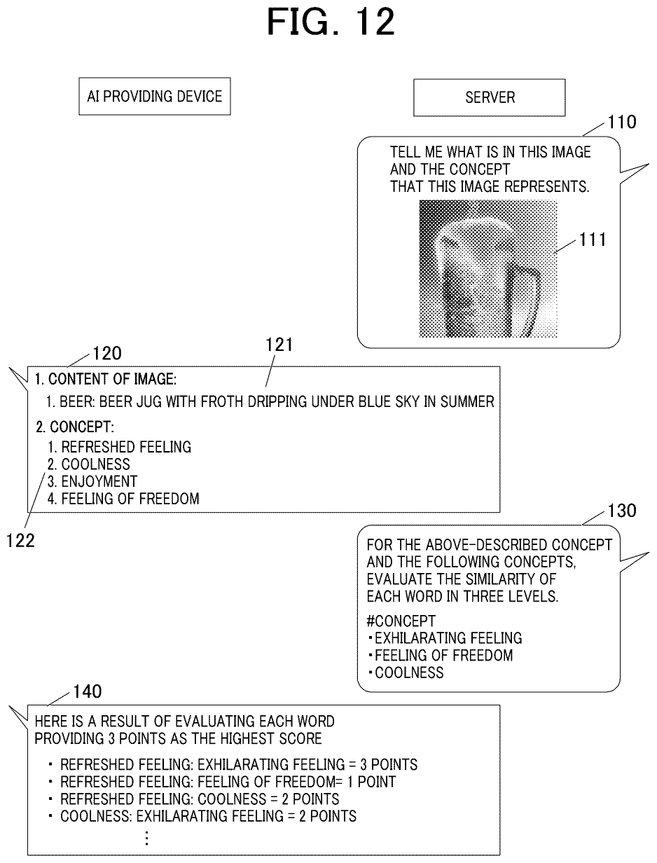

A third embodiment according to the present disclosure will be described with reference to FIG. 12. FIG. 12 is a diagram illustrating an example of information exchanged between the AI providing device 30 and the server 10.

According to the first embodiment described above, the server 10 stores the synonym database, and the synonym database is used to perform the concept evaluation processing. In the present embodiment, the AI providing device 30 provides the LLM, and the server 10 performs the concept evaluation processing using the LLM.

The apparatus configuration according to the present embodiment uses the image generating system 1, similarly to the first embodiment. The AI providing device 30 provides the LLM. The LLM of the AI providing device 30 is the AI to which the first concept information is input in a state where the second concept information is being generated. Similarly to step S122 of the image providing processing, the LLM performs concept evaluation by comparing the second concept information with the first concept information using the synonyms, and outputs the evaluation result. Therefore, the server 10 does not store the synonym database in the storage section 13.

Next, with reference to FIG. 12, the operation of the image generating system 1 will be described. Similarly to the second embodiment, the image providing processing of FIG. 7 and FIG. 8 is executed by the server 10. Here, the parts different from the image providing processing of the second embodiment will be mainly described, and the description of the same parts will be omitted.

Steps S111 to S121 of the image providing processing are similar to those of the second embodiment. In the concept evaluation processing of step S122, the controller 11 of the server 10 acquires the first concept information of step S112 and the second concept information of step S119. The controller 11 transmits the acquired first concept information and second concept information to the AI providing device 30 for the LLM via the communication section 15.

The AI providing device 30 receives the first concept information and the second concept information from the server 10 and inputs the information to the LLM. The LLM compares the received second concept information with the received first concept information, calculates the evaluation value as the evaluation result of the concept evaluation, and transmits the evaluation value to the server 10. Steps S123 to S126 of the image providing processing are similar to those of the second embodiment.

Here, an example of the present embodiment will be described with reference to FIG. 12. Here, it is assumed that “exhilarating feeling”, “feeling of freedom”, and “coolness” are input as the concept of the first concept information by the user corresponding to step S111 of the image providing processing. The user desires to generate the second image for a poster. Further, corresponding to step S111, the article information “beer mug” is input.

In correspondence with step S116, the image data of the second image 111 is generated. In step S118, the controller 11 of the server 10 generates the second prompt 110 and transmits the second prompt 110 to the AI providing device 30 together with the image data of the second image 111. Here, the second prompt 110 includes the text requesting the image content of the second image 111 together with the text requesting the second concept information. The second generative AI model of the AI providing device 30 generates the article information 121 and the second concept information 122 of the second image 111 from the received image data and the second prompt 110 of the second image 111. The second concept information 120 includes the concepts “refreshing feeling”, “coolness”, “enjoyment”, and “feeling of freedom” together with the text of the image content of the second image 111. In step S121, the controller 11 compares the article information “beer mug” received in step S112 with the article information 121 and generates the evaluation result of the article evaluation.

In step S122, the controller 11 generates the prompt 130 and sends the prompt 130 to the LLM of the AI providing device 30. The prompt 130 includes the first concept information and the request for a three level evaluation method in the concept evaluation. The LLM acquires the four concepts of the second concept information 120 from the second generative AI model or the server 10. The LLM generates the evaluation result 140 of the second concept information by using the received prompt 130. The LLM transmits the evaluation result 140 to the server 10. For example, the image data in which the total score of the evaluation result of the article evaluation and the evaluation result 140 is the highest among the predetermined number of sheets of generated image data corresponding to step S126 is displayed on the terminal device 20.

As described above, according to the present embodiment, the controller 11 inputs the first concept information and the second concept information for each image data into the LLM, and acquires the higher evaluation value as the degree of similarity becomes higher. Therefore, the degree to which the second concept information of the image data is similar to the first concept information can be evaluated more accurately.

Further, the image generating system 1 includes the AI providing device 30 that provides the LLM. Therefore, the configuration of the server 10 can be simplified.

Although an example in which the storage section (HDD or SSD) is used as a computer-readable medium for the program according to the present disclosure has been disclosed in the above description, the medium is not limited to this example. As other computer-readable media, a nonvolatile memory such as a flash memory and a portable storage medium such as a CD-ROM can be applied. Furthermore, a carrier wave is also applied to the present disclosure as a medium that provides data of the program according to the present disclosure via a communication line.

Note that the descriptions in the second and third embodiment are examples of the image generating system, the image generating method, and the program according to the present disclosure, and the present disclosure is not limited thereto. For example, the second embodiment and the third embodiment may be combined as appropriate.

Furthermore, in the second and third embodiment described above, the AI providing device 30 is configured to provide the first generative AI, the second generative AI, and the LLM, but it is not limited to this. The server 10 itself may have the function of providing the first generative AI, the second generative AI, and the LLM.

Furthermore, in the second and third embodiments described above, the number of sheets of the image data to be generated is a predetermined number of sheets set in advance, but it is not limited thereto. A feature of the image generating AI is that the image data generated in response to the same prompt is different every time. Therefore, in order to obtain desired image data, it is appropriate to increase the number of trials, that is, the number of sheets of image data (predetermined number of sheets of image data) to be generated. The controller 21 of the terminal device 20 may accept input of the setting for the predetermined number of sheets of the image data from the user via the operation part 22. For example, when accepting the input of the first concept information from the user via the operation part 22, the controller 21 may accept input of the setting of the first concept information including the number of sheets of the image data to be generated. The number of sheets of the image data to be generated input on the terminal device 20 is transmitted to the server 10. The controller 11 of the server 10 sets the predetermined number of sheets of the received image data as the predetermined number of sheets in step S117 in the image providing processing. That is, the predetermined number of sheets of the image data is the number of sheets input by operation from the user via the operation part 22. Therefore, the user can specify the number of sheets of the image data to be generated. The predetermined number of sheets can be increased to increase completeness of the image data for the desired concept. Alternatively, it is possible to shorten the amount of time required for generating and evaluating the image data by reducing the predetermined number of sheets.

Although embodiments of the present disclosure have been described and illustrated in detail, the disclosed embodiment are made for purposes of illustration and example only, and not limitation. The scope of the present disclosure should be interpreted by the terms of the appended claims.

What is claimed is:

1. An image generating system comprising:
a hardware processor that is configured to acquire concept information including a concept of an image desired by a user and a target value in an evaluation value of image data, cause a generative AI model to generate a plurality of image data based on a prompt corresponding to the acquired concept information, evaluate each of the generated image data, and select at least one image data in which the evaluated evaluation value is closer to the target value.

2. The image generating system according to claim 1, wherein the hardware processor displays the selected image data on a display.

3. The image generating system according to claim 1, wherein the hardware processor acquires draft image data, concept information, and a target value, and causes the generative AI model to generate a plurality of image data based on a prompt corresponding to the acquired draft image data and concept information.

4. The image generating system according to claim 1, wherein the hardware processor generates, based on the selected image data, the evaluation value, and the target value, a modified prompt for causing the evaluation value to further approach the target value, and inputs the modified prompt to the generative AI model.

5. The image generating system according to claim 4, wherein the hardware processor repeats generating the modified prompt and generating the image data based on the modified prompt until the evaluation value falls within a predetermined threshold value from the target value.

6. The image generating system according to claim 1, wherein the evaluation is an evaluation of at least one of an impression and a region of interest in an image of the generated image data.

7. The image generating system according to claim 4, wherein,
the evaluation is the evaluation of an impression in the image of the generated image data, and
the hardware processor generates the modified prompt such that the evaluation value of the impression is within a predetermined threshold value from the target value.

8. The image generating system according to claim 4, wherein,
the evaluation is the evaluation of a region of interest in the image of the generated image data, and
the hardware processor generates the modified prompt so as to change a region other than a region of interest when the evaluation value of a degree of attention of the region of interest is within a predetermined threshold value.

9. The image generating system according to claim 1, further comprising a provider that provides the generative AI model.

10. An image generating method comprising:
acquiring concept information including a concept of an image desired by a user and a target value in an evaluation value of image data;
causing a generative AI model to generate a plurality of image data based on a prompt corresponding to the acquired concept information;
evaluating each of the generated image data; and
selecting at least one image data in which the evaluated evaluation value is closer to the target value.

11. A non-transitory computer-readable storage medium storing a program that causes a hardware processor in a computer to:
acquire concept information including a concept of an image desired by a user and a target value in an evaluation value of image data, cause a generative AI model to generate a plurality of image data based on a prompt corresponding to the acquired concept information, evaluate each of the generated image data, and select at least one image data in which the evaluated evaluation value is closer to the target value.

12. An image generating system comprising:
a hardware processor that is configured to, acquire first concept information including a concept of an image desired by a user, generate a predetermined number of sheets of image data by inputting the acquired first concept information to a first generative AI model that generates the image data based on the concept information, generate second concept information by inputting the generated image data in a second generative AI model that generates the concept based on the image data, and evaluate, for each image data, a degree of similarity between the first concept information and the second concept information.

13. The image generating system according to claim 12, wherein,
the first generative AI model generates the image data based on element information including an image element included in the generated image data and concept information,
the hardware processor acquires the element information including an element desired by the user and the first concept information,
the hardware processor inputs the acquired element information and the acquired first concept information to the first generative AI model to generate a plurality of image data, and
the hardware processor evaluates a degree of similarity between the element information obtained from each of the image data and the acquired element information.

14. The image generating system according to claim 12, wherein the hardware processor displays the image data on a display.

15. The image generating system according to claim 14, wherein the hardware processor displays either one of (i) the image data with a highest evaluation result of the evaluation, or (ii) the plurality of image data with the high evaluation result and the evaluation result corresponding to the image data.

16. The image generating system according to claim 12, wherein the hardware processor generates, for each of the image data, a higher evaluation value as a degree of similarity of concepts between the first concept information and the second concept information becomes higher, using a synonym database.

17. The image generating system according to claim 12, wherein the hardware processor inputs the first concept information and the second concept information into LLM for each image data, and acquires a higher evaluation value as a degree of similarity becomes higher.

18. The image generating system according to claim 12, wherein the predetermined number of sheets is the preset number of sheets or the number of sheets input by operation via an operator.

19. The image generating system according to claim 12, further comprising a first provider that provides the first generative AI model and the second generative AI model.

20. The image generating system according to claim 17, further comprising a second provider that provides the LLM.

21. An image generating method comprising:
acquiring first concept information including a concept of an image desired by a user,
generating a predetermined number of sheets of image data by inputting the acquired first concept information to a first generative AI model that generates the image data based on the concept information,
generating second concept information by inputting the generated image data in a second generative AI model that generates the concept based on the image data, and
evaluating for each image data, a degree of similarity between the first concept information and the second concept information.

22. A non-transitory computer-readable storage medium storing a program that causes a hardware processor in a computer to:
acquire first concept information including a concept of an image desired by a user, generate a predetermined number of sheets of image data by inputting the acquired first concept information to a first generative AI model that generates the image data based on the concept information, generate second concept information by inputting the generated image data in a second generative AI model that generates the concept based on the image data, and evaluate, for each image data, a degree of similarity between the first concept information and the second concept information.
